(19) United States
(12) Patent Application Publication
(10) Pub. No.: US 2005/0233087 A1
(43) Pub. Date: Oct. 20, 2005

(54) Thermal fatigue crack-resistant coatings for motor vehicle cylinder head

(75) Inventor: Seok Ha, Gyeonggi-do (KR)

Correspondence Address: EDWARDS & ANGELL, LLP, P.O. BOX 55874, BOSTON, MA, 02205, US

(73) Assignee: Hyundai Motor Company, Seoul (KR)

(21) Appl. No.: 10/993,725

(22) Filed: Nov. 19, 2004

(30) Foreign Application Priority Data
Apr. 16, 2004 (KR) 2004-26135

(51) Int. Cl. B05D 7/00

(52) U.S. Cl. 427/421.1; 427/372.2

(57) ABSTRACT

Methods are provided for coating a zirconia film that can reduce or prevent the occurrence of thermal fatigue cracks of a cylinder head of a diesel engine. The invention also relates to spray coat application of a zirconia composition onto an aluminium surface or part of a motor vehicle. Preferred methods of the invention include spray coating to form a zirconia film wherein the phase of the thin zirconia film is preferably formed in a tetragonal phase with semi-stability, and the morphological change of the coating layer into a monoclinic phase can result in absorption of crack stress, i.e. crack energy, which can lead to increased resistance in preventing crack propagation.

### CROSS REFERENCE TO RELATED APPLICATIONS

This application is based on, and claims priority from Korean Application No. 2004-0026135, filed on Apr. 16, 2004, the disclosure of which is hereby incorporated by reference.

### FIELD OF THE INVENTION

The present invention relates in preferred aspects to methods of coating a zirconia film on a cylinder head of a diesel engine. Preferred methods of the invention can reduce the occurrence of thermal fatigue cracks of a cylinder head. The invention also relates to spray coat application of a zirconia composition onto an aluminium part of a motor vehicle.

### BACKGROUND OF THE INVENTION

Generally, the cylinder head of a diesel engine requires a relatively high strength, elongation and good surface. In the past, the surfaces of conventional cylinder heads of diesel engines were not treated. However, the recent increase in explosion pressure required for diesel engines has necessitated an increased resistance for the cylinder head combustion chamber. As a result, it has become more important to strengthen the combustion chamber part of a vehicle cylinder head.

In this regard, zirconia has been used due to its heat resistance and aluminium-conjugating capability (Japanese Patent Unexamined Publication Hei 3-225035, Japanese Patent Unexamined Publication Sho 60-88847, and Japanese Patent Unexamined Publication Sho 59-41624). In general, efforts to improve thermal fatigue crack of a diesel engine cylinder head have been made by a dipping process where a substrate is dipped into a zirconia sol and then removed from the fluid bath. The dipping process proceeds in a generally continuous fashion; however, the shape of the cylinder head is not flat and thus the thickness of the applied coating layer can vary, which can compromise performance results. In particular, variations in the thickness of the applied coating layer can result in non-uniform distribution of heat stress, including to concentrate heat stress to a relatively thin part. Further, in a dipping process, the entire head typically must be immersed in the fluid composition and thus local coating restricted to a certain part area cannot be easily performed.

The information set forth in this Background of the Invention section is only for enhancement of understanding of the background of the invention and should not be taken as an acknowledgement or any form of suggestion that this information forms the prior art that is already known to a person skilled in the art.

### SUMMARY OF THE INVENTION

In one aspect, the present invention provides methods of coating on the cylinder head of a diesel engine wherein the coating is restricted to a specified part or area.

Preferred methods of the invention include spray coating application of a zirconia material to a cylinder head of a diesel engine, preferably to a combustion chamber of a cylinder head. Preferably, the zirconia is formulated in a fluid composition such as a solution or a sol that comprises one or more zirconia materials. Preferably, the zirconia composition is applied as a relatively thin coating layer, e.g. a coating layer having a thickness of about 2000 nm or less, 1000 nm or less, or 500 nm or less after removal of any solvent carrier.

In another aspect, the invention provides methods that include spray coating application of a zirconia composition onto an aluminium part of a motor vehicle. Again, preferably the zirconia is formulated in a fluid composition such as a solution or a sol that comprises one or more zirconia materials. Preferably, the zirconia composition is applied as a relatively thin coating layer, e.g. a coating layer having a thickness of about 2000 nm or less, 1000 nm or less, or 500 nm or less after removal of any solvent carrier.

Preferably, the zirconia material(s) are applied to diesel engine cylinder head (such as the combustion chamber of the cylinder chamber) or aluminium surface or aluminium part of a motor vehicle in substantially uniform coating layer thickness, e.g. where the deviation of the coating layer thickness is about 20, 10 or 5 percent or less across a square centimeter of the coating layer.

Methods of the invention also can enable convenient application of a coating layer to a restricted area of a motor vehicle or motor vehicle part that preferably comprises aluminium. For instance, the spray coating can be restricted to targeted area(s) of an aluminium part (such as a combustion chamber of a diesel engine cylinder head). Additionally, appropriate masking techniques can be employed, e.g. where an area not intended for coating is masked with tape or other material to avoid deposition of the zirconia composition.

As referred to herein, the term “spray coating” or other similar term is intended to have the meaning understood by workers in this area, which includes the application of a coating composition (which often is a fluid composition such as a sol composition) to a substrate by an applicator such as a spray gun that delivers the fluid composition. This is distinguished from a dip coating process where a part to be coating is immersed (dipped) in a volume of a fluid composition.

It is understood that the term “vehicle” or other similar term as used herein is inclusive of motor vehicles in general such as passenger automobiles, buses, trucks, various commercial vehicles, watercraft, aircraft, and the like.

Other aspects of the invention are discussed below.

### BRIEF DESCRIPTION OF THE DRAWINGS

The aforementioned aspects and other features of the present invention will be explained in the following description, taken in conjunction with the accompanying drawings, wherein:

FIG. 1 is a cross-sectional picture of a thin zirconia film prepared according to an embodiment of the present invention, and

FIG. 2 is a cross-sectional picture of a thin zirconia film prepared according to the conventional dipping method.

### DETAILED DESCRIPTION OF THE INVENTION

In a preferred embodiment of the present invention there is provided a method of coating a zirconia film which can reduce or prevent the occurrence of thermal fatigue cracks on a cylinder head of a diesel engine or aluminium surface and/or aluminium part of a motor vehicle.

Particularly preferred methods of the invention comprise spray coating a zirconia composition onto a motor vehicle surface or part that comprises aluminium (such as a combustion chamber of a diesel engine cylinder head) where the aluminium-containing substrate has been heated prior to spray coating, e.g. where the substrate has been heated to at least about 200° C. or 250° C. Preferably, after the zirconia composition has been applied, the coated substrate is further heated, e.g. at least about 200° C., 300° C. or 400° C. for greater than 0.5 hour, e.g. at least about 1, 2, 3 or 4 hours.

Without by bound by any theory, we have found that the presence of compressive residual stress on the surface of the cylinder head can reduce or prevent the occurrence of thermal fatigue cracks. We also found that it can be important to minimize the change in stress that may result from a change in coating layer shape by optimizing the thickness of a coated layer which can affect the compressive residual stress. In particular, we found that it can be important to maintain a substantially uniform thickness of the coated layer, as discussed above.

Thus, in one aspect, the present invention provides methods of coating a zirconia film which can establish a compressive residual stress on the surface of a cylinder head or aluminium surface of a motor vehicle.

Pure zirconia is monoclinic at room temperature having a melting temperature of 2677° C., density of 5.6 g/cm³, heat expansion coefficient of 6.5×10⁻⁶/° C. is very stable at high temperature conditions. The phase transition of zirconia occurs at 2677° C., 2677° C., and 2677° C., respectively, and is subject to have the phase of monoclinic, tetragonal and cube melt, respectively. Here, the phase transition incurs martensitic phase transformation which entails change in volume of 3-4%, and it cannot be effectively employed because of cracks generated due to change in volume during phase transition. Therefore, it can be beneficial to maintain a stabilized phase at room temperature. Such a stabilized phase can be suitably provided by including in the applied zirconia composition one or more stabilizers such as e.g. one or more of Y₂O₃, MgO, CaO, CeO₂, and Er₂O₃. Without being bound by any theory, the addition of such stabilizers to zirconia can promote the zirconia to have a metastable phase such as a tetragonal phase or a cubic melt phase. These metastable phases can exhibit linear heat expansion at high temperatures without any phase transition.

Again, without by bound by any theory, if a metastable cubic melt phase is present within the stress field of a given crack the stress can be absorbed by the metastable cubic melt and it can undergo a phase transition into a monoclinic phase wherein the crack propagation energy is reduced. This effect can thereby increase toughness of the applied coating layer.

In another preferred embodiment of the present invention methods are provided for preparing a zirconia film which can reduce or prevent the occurrence of thermal fatigue cracks of a motor vehicle cylinder head by spray coating application of a zirconia film in a mestastable cubic melt phase. The thus formed zirconia film can absorb crack stress, e.g. crack energy, due to the phase transformation of the thin zirconia film from the metastable phase to a monoclinic phase, thereby improving toughness of the zirconia film, which can prevent crack propagation.

A particularly preferred zirconia composition for in the methods of the invention may be prepared as follows. Other suitable zirconia compositions may be prepared by the same or appropriately modified procedures.

A method for synthesizing a precursor for zirconia alkoxide, Zr(OC₃H₇)₃, is as follows: Synthesis of Zirconia Alkoxide: Zr(OC₃H₇)₃: Addition of alkoxide (Y(OC₃H₇)₃)→Preparation of a common alcohol solution →Addition of H₂O→Hydrolysis→Generation of precipitate of zirconia hydrate→Filtration and Wash→Drying→Calcination (850° C., 0.5 hr)→ZrO₂ powder with Y₂O₃ solid solution. The thus prepared zirconia powder is added with pyridine to produce a zirconia sol. The zirconia sol composition may be applied to a cylinder head (particularly combustion chamber) and/or aluminium surface of a motor vehicle or motor vehicle part, particularly by spray coating.

This invention is explained in greater detail based on the following Examples and but they should not be construed as limiting the scope of this invention.

### EXAMPLES

Zirconia sol prepared as disclosed above (i.e. via Zr(OC₃H₇)₃ to produce zirconia powder which is mixed with pyridine to provide zirconia sol composition) was spray coated on an aluminum substrate to the thickness of 500 nm, placed under heat treatment at 400° C. for at least 3 hours and the temperature of the substrate was kept at 250° C. or higher. Since it is not possible to increase the temperature of a substrate during dipping process, a specimen which was heat treated after coating at room temperature was placed for thermal fatigue crack test and the presence of thermal fatigue crack was observed accordingly.

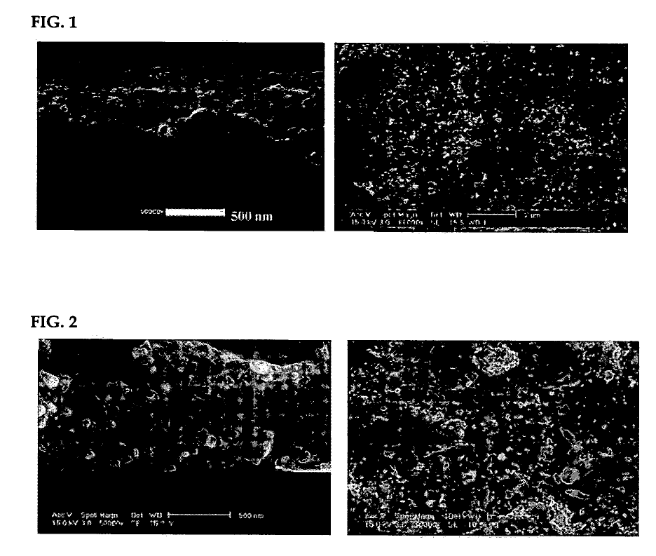

FIGS. 1 and 2 show cross-sectional view of specimens prepared according to the present invention and the dipping process of the conventional method, respectively. As shown in the FIGS. 1 and 2, the specimens prepared according to the present invention (FIG. 1) have superior illuminance as compared to those prepared by the conventional method (FIG. 2). As seen in FIG. 1, a coating with uniform thickness is possible in the event of spray coating, while it is very difficult to have a coating with uniform thickness when the specimens are prepared by the conventional method because the coating is separated from the substrate as in the case of Comparative Examples.

The following table 1 compares the effects between particularly preferred methods of the present invention and that of conventional method. In the present invention, spray coating process is same as in the table 1 and was followed with heat treatment for at least 3 hours at 400° C.

TABLE 1

| | | Heat | | | |
|---|---|---|---|---|---|
| | Coating | Treatment | Heat | | |
| | Temp. | Temp. | Treatment | Presence | |
| No. | (° C.) | (° C.) | (hr) | of Cracks | Remark |
| 1 | 250 | 400 | 3 | No | Present |
| | | | | | Invention |
| 2 | 260 | 400 | 3 | No | Present |
| | | | | | Invention |
| 3 | 350 | 400 | 3 | No | Present |
| | | | | | Invention |
| 4 | 400 | 400 | 3 | No | Present |
| | | | | | Invention |
| 5 | 250 | 400 | 4 | No | Present |
| | | | | | Invention |
| 6 | 400 | 400 | 4 | No | Present |
| | | | | | Invention |
| 7 | 250 | 45 | 3 | No | Present |
| | | | | | Invention |
| 8 | Rm. | 400 | 3 | Yes | Conventional |
| | Temp. | | | | Method |
| 9 | Rm. | 400 | 4 | Yes | Conventional |
| | Temp. | | | | Method |
| 10 | Rm. | 400 | 5 | Yes | Conventional |
| | Temp. | | | | Method |
| 11 | Rm. | 400 | 10 | Yes | Conventional |
| | Temp. | | | | Method |
| 12 | 240 | 400 | 3 | Yes | Comp. Ex. |
| 13 | 250 | 350 | 3 | Yes | Comp. Ex. |
| 14 | 250 | 350 | 5 | Yes | Comp. Ex. |
| 15 | 250 | 400 | 2 | Yes | Comp. Ex. |

As shown in the table 1, when the spray coating was performed at the substrate temperature of 250° C. or higher and the subsequent heat treatment was performed at 400° C. for 3 hr or more the resulting coated layer had a superior adhesion with the avoidance of cracks in the coating. Without being bound by any theory, this is believed to be due at least in part to a reduced lattice defect between the coated layer and the substrate in that temperature range, thereby increasing adhesion between the coating layer and underlying substrate. However, in Example 8, where the temperature of the substrate was not increased, the lattice defect is maintained without being reduced. Therefore, in that situation the adhesion between the coated layer and the substrate can become insufficient and result in generation of cracks.

In conventional methods, there is generally a change in microstructure as the time used for heat treatment increases. Thus, in Examples 9-11, where a dipping process was performed at room temperature followed by a relatively long period of time for heat treatment, formation of cracks was observed. This indicates that in the event of coating at room temperature the resulting metastable phase of zirconia with energy absorptivity may not be sufficient to prevent the generation of crack or the adhesion between the coated layer and the substrate can be deteriorated.

In Example 12, where the coating was performed at a temperature 10° C. lower than 250° C., cracks were observed, indicating that heating to at least 250° C. is beneficial.

In Example 13, where the heat treatment after coating was performed at 350° C., there were also cracks due to insufficient preparation of a coated layer suggesting the temperature at the time of heat treatment is related to the generation of cracks. In Example 14, where the time for heat treatment was extended, there was no significant change. These results suggest that the temperature of heat treatment should be at least 400° C. or higher. In Example 15, where the temperatures of coating and heat treatment were maintained as in other examples with the exception that the heat treatment time is 2 hour, there was no significant change with respect to prevention of cracks.

In preferred protocols, heat treatment is performed within a limited period of time e.g. less than about 6 hours, preferably less than 5 hours or no more than 4 hours such as from 2 or 3 hours to 4 hours. Heat treatment in excess of those times can lead to crack propagation due to transformation of a substrate by decrease in hardness resulting from structural change in the substrate of the cylinder head.

As shown in the above Examples, the present invention, by means of spray coating, enables application of a coated layer which can prevent generation of thermal fatigue crack.

Consequently, in particularly preferred aspects, the present invention provides methods of applying a zirconia film via spray coating to a substrate surface heated to about 250° C. or higher to have superior adhesion between the coated layer and the substrate. Again, without being bound by any theory, post-application heating of the coated substrate can result in the applied zirconia film to develop into a tetragonal phase thus allowing the film to have a metastable phase at room temperature. Therefore, it is possible to safeguard the quality of parts that comprise aluminum by prevention or reduction of thermal fatigue cracks. Additionally, the invention enables further quality improvements by offering more convenient coating of parts with varying shapes and designs.

All documents mentioned herein are fully incorporated herein by reference in their entirety.

While the invention has been described with reference to specific embodiments, modifications and variations of the invention may be constructed with departing from the scope of the invention, which is defined in the following claims.

1. A method of applying zirconia layer to a cylinder head of a diesel engine, the method comprising: spray coating a zirconia composition onto a diesel engine cylinder head.

2. The method of claim 1 wherein the zirconia composition is restricted to a combustion chamber of the cylinder head.

3. The method of claim 1 wherein a zirconia composition in the form of a sol is spray coated onto the cylinder head.

4. The method of claim 1, wherein the spray coating is performed with the cylinder head area to be coated at a temperature of about 250° C. or higher.

5. The method of claim 1 wherein the coated cylinder head area is heated at about 400° C. or higher.

6. The method of claim 5 wherein the coated cylinder head area is heated for less than about 6 hours.

7. The method of claim 1, wherein the zirconia sol composition comprises one or more stabilizers selected from the group consisting of Y₂O₃, MgO, CaO, CeO₂, and Er₂O₃.

8. A method of applying zirconia layer to an aluminium surface of a motor vehicle, the method comprising spray coating a zirconia composition onto the aluminium surface.
